(19) United States
(12) Patent Application Publication
(10) Pub. No.: US 2021/0276593 A1
(43) Pub. Date: Sep. 9, 2021

(54) AUTOMATED AND INTERCHANGEABLE FUNCTIONAL DEVICE

(71) Applicant: Next Energy, LLC, Canton, MI (US)

(72) Inventors: Claudio B Bucur, Canton, MI (US); Christian Arthur Trager, Canton, MI (US); Juliano Regis de Vilas Boas, Canton, MI (US)

(73) Assignee: Next Energy, LLC, Canton, MI (US)

(21) Appl. No.: 16/800,765

(22) Filed: Feb. 25, 2020

(51) Int. Cl. B60W 60/00; E01H 5/09; A01D 34/00

(52) U.S. Cl. CPC B60W 60/0025; A01D 2101/00; A01D 34/008; E01H 5/098

(57) ABSTRACT

An interchangeable device for perming the tasks of lawnmowing and snow blowing. The device comprising a motive component to provide motion to a functional component. The motive component comprising a motor to drive a motion element in communication with a microcontroller configured to provide autonomous motion to the motive component. A functional component is arranged to perform a task, the functional component releasably engaged with the motive component to allow the functional component to be interchanged.

### TECHNICAL FIELD

The present disclosure generally relates to devices which perform the tasks of lawnmowing and snow blowing.

### BACKGROUND

Currently, there are a variety of commercial lawnmowers and snow blowers available for purchase from retailers. These devices are often powered by combustion engines and require an operator to operate the machine during use as well as maintain the engine throughout the lifetime of the device. This significantly raises the operations costs for landscaping companies who need to pay an operator for the duration of the lawnmowing or snow blowing time of labor, purchase and supply fuel, and supply transportation means to the operator and lawnmower/snow blower.

The machines are often large and expensive, the landscaper will purchase large, powerful, and fast machines which will be transported between customers by a truck and trailer. The common business model is to purchase the largest and most powerful lawnmower/snow blower and move it between customers to complete each job as fast as possible. This leads to a large logistics cost since large trucks and trailers must be purchased and maintained. In addition, the landscaping company needs to purchase separate devices for the warm and cold months, respectively, by purchasing a lawnmower during the warm months, and a snow blower in the cold months.

The progression in the arts of efficient power sources has allowed for the movement away from combustion engines to electrically powered machines. This reduces maintenance costs, eliminates the need to purchase and supply fuel, and allows for new configurations of machines.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide for an interchangeable device for perming the tasks of lawnmowing and snow blowing. The device comprising a motive component to provide motion to a functional component. The motive component comprising a motor to drive a motion element in communication with a microcontroller configured to provide autonomous motion to the motive component. A functional component is arranged to perform a task, the functional component releasably engaged with the motive component to allow the functional component to be interchanged.

The system provides a single machine which can perform the tasks of lawnmowing and snow blowing. The system may be autonomously operated to not require an operator. The system is powered by an electric motor which is self-charging.

In one aspect, a plurality of sensors are in operable communication with a microcontroller, the plurality of sensors comprising a motion sensor, a thermal sensor, a proximity sensor, an optical sensor, a light sensor, a microphone in operable communication with a sound-interpretation module, one or more cameras, an infrared sensor, and one or more GPS components.

In one aspect, the motion element is a track belt in operable communication with a motor. In alternative embodiments, the motion element is a plurality of wheels and tires. Various motion elements may be used depending on the surface, and seasonal characteristics.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the functional component, according to some embodiments;

FIG. 2 illustrates a side elevation view of the functional component and motive component, according to some embodiments;

FIG. 3 illustrates a perspective view of the motive component, according to some embodiments;

FIG. 4 illustrates a schematic of the computer system and the functional component, according to some embodiments;

FIG. 5 illustrates a perspective view of the cutting element, according to some embodiments;

FIG. 6 illustrates a perspective view of the housing, according to some embodiments;

FIG. 7 illustrates a perspective view of the housing, according to some embodiments;

FIG. 8 illustrates a perspective view of the housing, according to some embodiments;

FIG. 9 illustrates a perspective view of the housing, according to some embodiments;

FIG. 10 illustrates a perspective view of the housing, according to some embodiments; and

FIG. 11 illustrates a block diagram of the network infrastructure, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

In general, the embodiments disclosed herein relate to a lawnmowing and snow blowing system which includes a motive component removably engaged with a plurality of functional components. The functional components may include at least one lawnmowing component and at least one snow blowing component such that the user can selectively engage each functional component depending on the need for a particular task which the functional component performs. For example, during the warm months wherein lawnmowing is desired, the user engages the lawnmower component to the motive component. During the cold months when snow removal is needed, the user disengages the lawnmower component and engages the snow blower component.

In some embodiments, the system is autonomous to eliminate the need for an operator. The electric motor may be self-charging such that, for example, the power supply to the electric motor transmits an alert signal when a threshold is reached to instruct the system to begin a self-charging sequence.

The system is beneficial over current system in that it reduces logistics costs by removing the need for purchasing separate machines for lawnmowing and snow blowing by permitting the readily interchangeable lawnmowing device and snow blowing device. The electric motor greatly reduces maintenance costs and may even be calibrated, inspected, or otherwise modified remotely via a communications network.

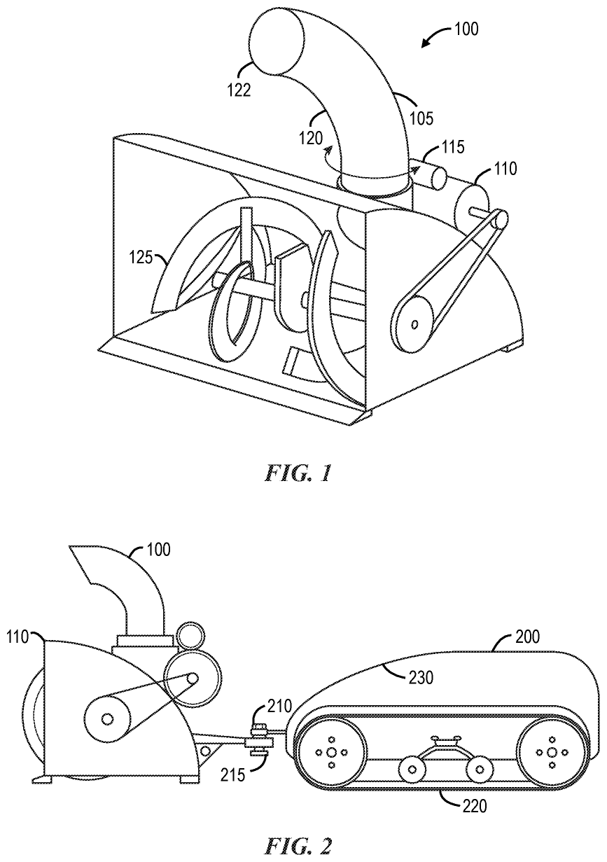

In reference to FIG. 1, an exemplary functional component is illustrated, according to some embodiments. The functional component 100 is configured as a snow blower 105 having a motor 110 in functional communication with a gear 115 in operable communication with a direct chute discharge 120 in fluid communication with the aperture 122 to allow for the egress of snow or other debris. A cutting element 125 is suitably arranged to collect and emit snow or other debris via cutting element 125 as the functional component moves over a surface covered in snow or other debris.

The cutting element may be a reel, such as the reels used in non-motorized push snow blowers or push movers in the prior art, or may be any other cutting element known in the arts.

In some embodiments, the motor may be a stepper motor, including other forms of brushless DC electric motors.

FIG. 2 illustrates the functional component 100 shown as a snow blower 110 which may also be embodied as a lawnmower having a motive component 200 removably engaged thereto. The motive component 200 is configured to provide motion to the functional component 100 to allow the functional component 100 to move and accomplish a task (e.g., cutting grass, snow blowing, etc.). Connection element 210 provides a means for removeable engaging the functional component 100 from the motive component 200. The motive component 200 includes a motion element 220 such as a plurality of wheels or a track belt driven by a motor within the housing 230 of the motive component 200.

In some embodiments, the connection element may be one or more heim joints 215 (as shown in FIG. 2), or similar rotational or articulating joint configurations known in the arts. For particular embodiments of the functional component, it may be beneficial for the connection element to allow only up and down movement or only side to side movement depending on the application of the functional component or terrain in which the functional component is operating. The connection element should be easily engaged, disengaged, and reengaged to allow for quick connection and disconnection between the functional component and the motive component.

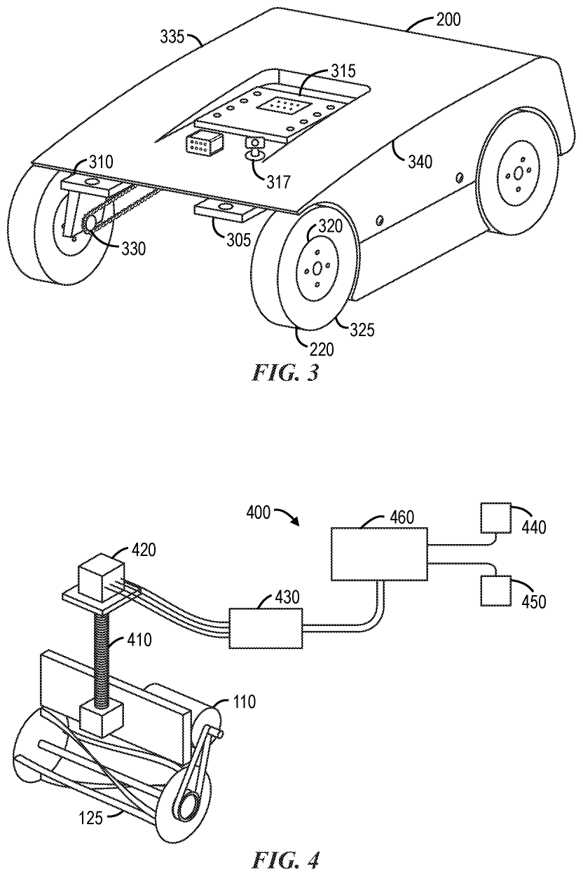

In reference to FIG. 3, the motive component 200 and associated components are illustrated according to some embodiments. The motive component 200 comprises first and second mounting tabs 305,310 to connect to the connection element (shown in FIG. 2). The mounting tabs 305,310 allow for rapid attachment and removal of the motive component 200 from the functional component in embodiments wherein the joint is fixed to each end. For example, the mounting tabs allow for the user to change between a lawnmower functional component and a snow blower functional component. A mount 315 allows for a plurality of sensors 317 to be mounted to the housing 230 to perform various autonomous actions during operation of the system. A plurality of wheels 320 and tires 325 are illustrated as the motion elements 220, which may be interchanged with a track belt for various operational needs, such as operation in snow and/or ice conditions. In one example, the wheels 320 and tires 325 are pneumatically operated by having a gear motor 330 on each of the left side 335 and the right side 340 of the motive component 200.

In some embodiments, the plurality of sensors may include but are not limited to at least one of the following, a motion sensor, a thermal sensor, a proximity sensor, an optical sensor, a light sensor, a microphone in operable communication with a sound-interpretation module, one or more cameras, an infrared sensor, a GPS, and other sensors, or navigational components known in the arts.

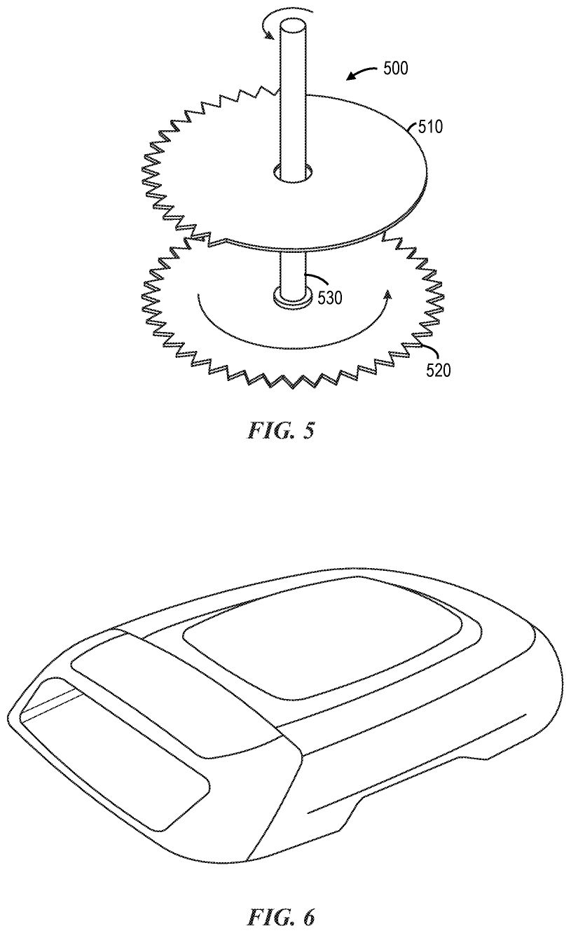

FIG. 4 illustrates a schematic of the vertical actuator system 400 for cutting grass. The vertical actuator system comprises a cutting element 125 in operable communication with the cutting element motor 110. A vertical actuator 410 connects the cutting element motor 110 with one or more stepper motors 420 driven by a stepper driver 430. GPS sensors 440,450 are in operable communication with a microcontroller 460 comprising a microprocessor to execute instructions and operate the motive component to perform a task, such as lawnmowing or snow blowing. In one example, the GPS sensors 440,450 transmit an output signal to the microcontroller 460 to instruct the microprocessor to move one or more of the moving elements.

FIG. 5 illustrates an alternative cutting element 500 which may be utilized by the functional component. In the illustrated embodiment, a stationary blade 510 is positioned adjacent to a moving blade 520 which rotates about an axis 530. The illustrated example may have advantages over a reel cutting element by providing a smoother cutting component and utilizing more power.

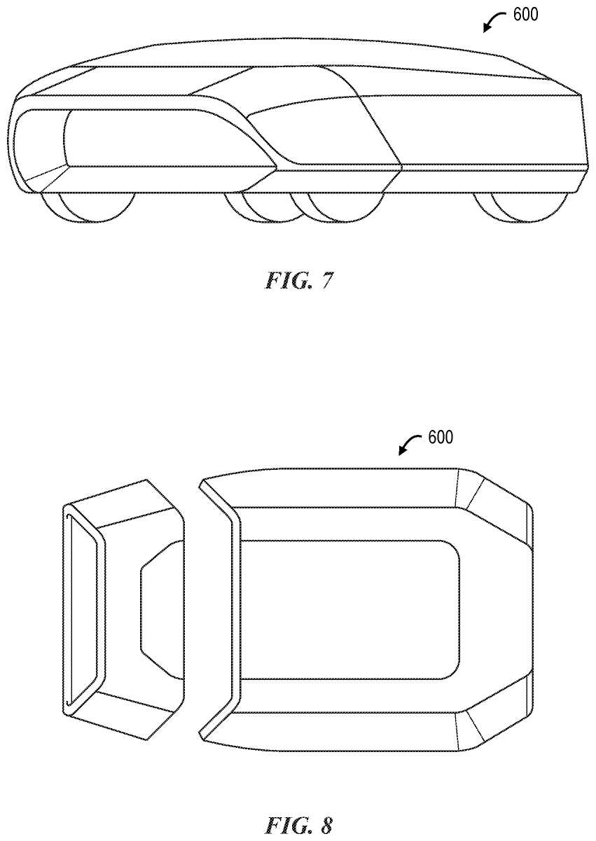

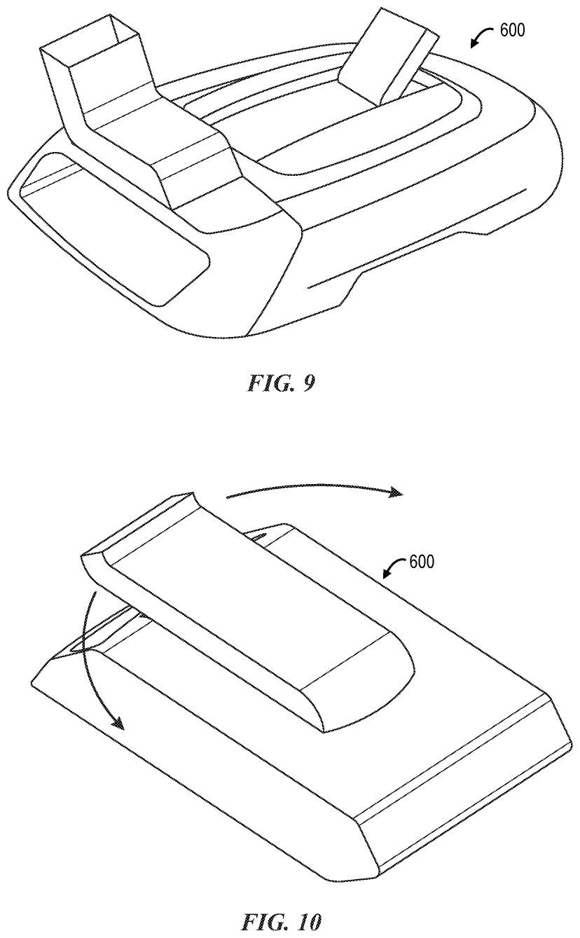

FIGS. 6-10 illustrate an exemplary housing 600 which may be used by the functional component or the motive component. The housing provides protection from the elements, provides protection from impacts, and may also be configured to be waterproof.

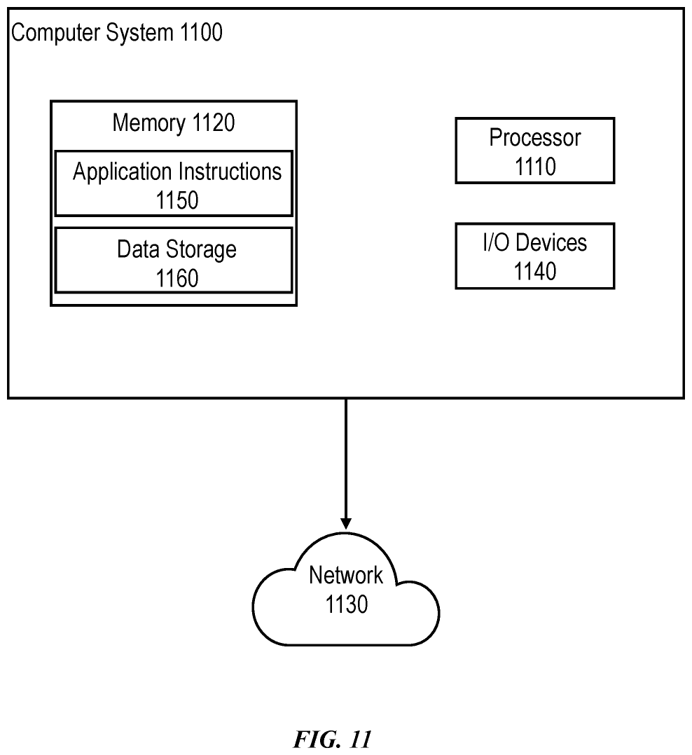

FIG. 11 illustrates an exemplary system infrastructure. The computer system allows for the remote operation, update, and control the device to perform the tasks described herein. A computer system 1100, which may be utilized to execute the processes described herein. The computing system 1100 is comprised of a computer system housed within the device or other computer system such as a standalone computer or mobile computing device, a mainframe computer system, a workstation, a network computer, a desktop computer, a laptop, or the like. The computer system 1100 includes one or more processors 1110 coupled to a memory 1120 via an input/output (I/O) interface. Computer system 1100 may further include a network interface to communicate with the network 1130. One or more input/output (I/O) devices 1140, such as video device(s) (e.g., a camera), audio device(s), and display(s) are in operable communication with the computer system 1100. In some embodiments, similar I/O devices 1140 may be separate from computer system 1100 and may interact with one or more nodes of the computer system 1100 through a wired or wireless connection, such as over a network interface.

Processors 1110 suitable for the execution of a computer program include both general and special purpose microprocessors and any one or more processors of any digital computing device. The processor 1110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 1100 and other devices attached to a network 1130, such as other computer systems, or between nodes of the computer system 1100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 1120 may include application instructions 1150, configured to implement certain embodiments described herein, and a database 1160, comprising various data accessible by the application instructions 1150. In one embodiment, the application instructions 1150 may include software elements corresponding to one or more of the various embodiments described herein. For example, application instructions 1150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 1100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 1110 such that the processor 1110 can read information from, and write information to, the storage medium. In the alternative, the storage medium may be integrated into the processor 1110. Further, in some embodiments, the processor 1110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system is provided in a small enough configuration to allow for the system to be stored at the customer site, rather than being transported by the landscaping company between customer sites. In such, the landscaping company may implement a leasing program to the customer, or similar program to further increase profits.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An interchangeable device for perming the tasks of lawnmowing and snow blowing, the device comprising:
a. a motive component comprising a motor to drive a motion element;
b. a functional component arranged to perform a task, the functional component releasably engaged with the motive component to allow the functional component to be interchanged.

2. The device of claim 1, further comprising a plurality of sensors in operable communication with a microcontroller, the plurality of sensors comprising a motion sensor, a thermal sensor, a proximity sensor, an optical sensor, a light sensor, a microphone in operable communication with a sound-interpretation module, one or more cameras, an infrared sensor, and one or more GPS components.

3. The device of claim 1, wherein motion element is a track belt in operable communication with a motor.

4. The device of claim 1, wherein the motion element is a plurality of wheels and tires.

5. The device of claim 1, wherein the motion element is pneumatically operated.

6. An interchangeable device for perming the tasks of lawnmowing and snow blowing, the device comprising:
a. a motive component to provide motion to a functional component, the motive component comprising a motor to drive a motion element in communication with a microcontroller configured to provide autonomous motion to the motive component;
b. a functional component arranged to perform a task, the functional component releasably engaged with the motive component to allow the functional component to be interchanged.

7. The device of claim 6, wherein a plurality of sensors are in operable communication with the microcontroller, the plurality of sensors comprising a motion sensor, a thermal sensor, a proximity sensor, an optical sensor, a light sensor, a microphone in operable communication with a sound-interpretation module, one or more cameras, an infrared sensor, and one or more GPS components.

8. The device of claim 6, wherein motion element is a track belt in operable communication with a motor.

9. The device of claim 6, wherein the motion element is a plurality of wheels and tires.

10. The device of claim 6, wherein the motion element is pneumatically operated.

11. The device of claim 6, wherein the functional component is comprised of a snow blower, the snowblower comprising a blade motor to operate a blade and expel snow through a direct chute discharge.

12. The device of claim 6, wherein the functional component is comprised of a lawn mower having one or more blades operable via a motor to cut grass.

13. An interchangeable device for perming the tasks of lawnmowing and snow blowing, the device comprising:
a. a network-connected motive component to provide motion to a rotationally engaged functional component, the motive component comprising a motor to drive a motion element in communication with a microcontroller configured to provide at least semi-autonomous motion to the motive component;
b. a network-connected functional component arranged to perform a task, the functional component releasably engaged with the motive component to allow the functional component to be interchanged between a lawnmower and a snowblower.

14. The device of claim 13, wherein a plurality of sensors are in operable communication with the microcontroller, the plurality of sensors comprising a motion sensor, a thermal sensor, a proximity sensor, an optical sensor, a light sensor, a microphone in operable communication with a sound-interpretation module, one or more cameras, an infrared sensor, and one or more GPS components.

15. The device of claim 14, wherein motion element is a track belt in operable communication with a motor.

16. The device of claim 14, wherein the motion element is a plurality of wheels and tires.

17. The device of claim 15, wherein the motion element is pneumatically operated.

18. The device of claim 17, wherein the snowblower comprises a blade motor to operate a blade and expel snow through a direct chute discharge.

19. The device of claim 18, wherein the functional component is comprised of a lawn mower having one or more blades operable via a motor to cut grass.
